(19) United States
(12) Patent Application Publication
(10) Pub. No.: US 2009/0310779 A1
(43) Pub. Date: Dec. 17, 2009

(54) METHOD FOR GENERATING CRYPTOGRAPHIC KEY FROM BIOMETRIC DATA

(75) Inventors: Kwok Yan Karch Lam, Singapore (SG); Yi Yuan Huang, Singapore (SG); Hong Wei Sun, Singapore (SG); Ka Wo Cheng, Singapore (SG)

Correspondence Address: BROOKS KUSHMAN P.C., 1000 TOWN CENTER, TWENTY-SECOND FLOOR, SOUTHFIELD, MI, 48075, US

(73) Assignee: PRIVYLINK PTE LTD, Singapore (SG)

(21) Appl. No.: 12/374,604

(22) PCT Filed: Jul. 19, 2007
(86) PCT No.: PCT/SG07/00213

§ 371 Date: Jan. 21, 2009

(30) Foreign Application Priority Data
Jul. 20, 2006 (SG) 200604906-8

(51) Int. Cl. H04L 9/00

(52) U.S. Cl. 380/46

(57) ABSTRACT

Data from biometric images such as minutiae of a fingerprint are represented in coordinates x- and y-, and the direction of the ridge flow of the minutia θ; in vector sets of (x₁, y₁, θ₁) are used in generating a 256-bit secret key in a secure manner in enrolling the fingerprint in the Enrolment Phase. The key generation algorithm includes random key generation, threshold signature scheme using polynomial functions, generating random fake minutiae vector sets to form a locked representation of the fingerprint. In the Query Phase, the fingerprint image used to re-generate the secret key is matched against the locked template representation through automatic alignment process using geometric hash table to compare the enrolled minutiae (genuine and fake) with the vector set extracted from the query minutiae sets, and adjustable transform equation is used for adjusting for the minutiae direction, etc.

### TECHNICAL FIELD

This invention relates to a cryptographic method, including encrypting and decrypting information. More particularly, it relates to encryption and authentication involving biometric data and using its unique characteristic, such as a fingerprint's minutiae, to generate a secret key using the cryptography's algorithm sets.

### BACKGROUND ART

As biometric data such as fingerprint image and iris pattern of a human is unique to the person, their use as a source of raw data to reduce characteristic points therefrom, such as the minutia points, and feature spaces from iris stroma and epithelium has been practiced in cryptography. Apart from the x- and y-axes coordinates, the direction of the biometric feature, such as the fingerprint's ridge flow direction, may also be taken as a parameter, thus forming a vector (x, y, θ) set of data to be used in the cryptographic process.

Generally, the objective of fingerprint biometric cryptography is to combine fingerprint biometrics with cryptography so as to enable a secret cryptographic key to be generated from a genuine fingerprint image. Fingerprint features are extracted from the ridge pattern of the fingerprint and are represented in a data structure known as fingerprint minutiae. The data structure representing a minutia comprises the coordinates pair (denoted by the pair (x, y)) of the minutia in the fingerprint and the direction (in angle θ) of the minutia. The collection or set of minutiae representing the features of a fingerprint is called a fingerprint template. The following patents may give a background to our present invention.

U.S. Pat. No. 6,301,376 (Draganoff) published 9 Oct. 2001 discloses a method of dealing with false minutiae which are not deliberately added to the genuine ones but which had arisen from defects, noise, dust, etc. The approach was to adjust by lowering and raising the false rejection or acceptance coefficients accordingly. The false minutiae are not generated randomly on purpose to add to the genuine minutiae to construct a value set for generating the cryptographic key. As for the direction of ridges, this patent teaches the use of segmented “yardsticks” which are linear sections of the fingerprint represented in the form of co-linear pixels in which the directions are noted. Rather than in form of the raw or natural direction of the ridges in angles, the co-linear pixels' directions are thus noted in terms of row-wise, column-wise data. There is no suggestion of using randomly generated false minutiae to add to the genuine minutiae to construct a securely encrypted value set for generating a cryptographic key.

U.S. Pat. No. 5,991,408 (Pearson) published 23 Nov. 1999 discloses a method of encoding minutiae data into vertices in a graph, whereby the vertices are then connected to form a clique. All or selected vertices of the clique may then be used to generate cryptographic key. False vertices and edges are then added to the graph as camouflage after the key generation. As this prior art method involves solving instances of hard mathematical problems, the secret key generated is a function of the biometric data of the user, i.e. the same unique key will be generated by the same user. The secret key generated by this prior art method is used in a public key cryptography system. There is no description of false minutia (i.e. false biometric data in raw form) being generated and added to the genuine ones before a representation of the fingerprint minutiae is produced.

The subject of taking the orientation or direction of minutiae as data is also described in U.S. Pat. No. 5,631,971 (Sparrow) published 20 May 1997. This patent discloses a rapid physical fingerprint matching process using a vector based topological method whereby the ridge flow direction, including the angle to the direction of the ridge flow, are employed. The angle of the minutia is used to project a reference line for analysing the ridges around the minutia. There is no disclosure on cryptography key generation.

U.S. Pat. No. 6,035,398 (Bjorn) published 7 Mar. 2000 appears to have disclosed 3 aspects of biometric cryptography disclosed above, i.e. false minutiae, direction of ridge flow being taken as a defining parameter of the minutia, and cryptographic key generation. In particular, ghost minutiae are added to genuine ones before they are digested by mathematical function, including one-way hashing using MD5, to generate the cryptographic key. The acceptable variations in the direction of flow of the randomly generated false minutiae's ridge are set at less than 90° to the genuine minutiae as such occurrence would be highly unlikely.

This prior art method basically uses hash function to generate the secret key from the biometric data, and which key is used in public key cryptography. The secret keys are calculated from the genuine points in the template, or calculated from ghost points (with the genuine points subtracted from the template). As the result of using a predetermined hash function, Bjorn's method results in the same key when the same fingerprint data is used.

Rigorousness of the particular hashing algorithm chosen for a biometric data-based cryptography is also an important consideration. For example, it has been reported that collision attacks on MD5 has been increasingly shortened from one hour with an IBM p690 cluster (Xiaoyun Wang, et al. August 2004—see http://eprint.iacr.org/2004/199) to less than a minute using a single laptop running a tunnelling algorithm (Vlastimil Klima, March 2006—see http://eprint.iacr.org/2006/105).

The Secure Hash Algorithm (SHA) family or set of cryptographic hash functions may be more rigorous than Message Digest algorithms such as MD5. Whilst attacks have been found for both SHA-0 and SHA-1 and no attacks have yet been reported on SHA-2, researchers are worried since it is similar to the earlier two SHA family members and are thus developing new candidates to provide higher output ranges for a better hashing standard. For example, SHACAL-2 has been developed as a 256-block cipher based upon the larger hash function SHA-256.

As a consequence of the potential fallibility of even the most sophisticated secure hashing algorithm, it is desirable to have a cryptographic key generation method whereby the hashing is not used to obtain the secret key. It would be advantageous if the key generation is randomised so that the key generated is not the same even though the same fingerprint is used. The secret key should not be generated by a hashing algorithm which, no matter how rigorous it is built, is still open to collision attacks.

### PURPOSE AND SUMMARY OF THE INVENTION

Our present invention endeavours to produce a cryptographic key that is more rigorous than previously known in the art by using a person's unique biometric features to produce unique raw data that may be transform and encrypted using our cryptographic algorithm which we shall now describe.

Our invention involves cryptographic secret sharing scheme, particularly threshold scheme as introduced by Adi Shamir in 1979 as a secret sharing scheme among a t or threshold number of participants or shares which is based on polynomial interpolation. A secret is transformed into a set of values called “secret shares” which is a concept in threshold scheme. The secret can be re-constructed from a subset of secret shares if there is at least a threshold number of secret shares in the subset. E.g. a secret may be transformed into 5 secret shares, any 3 out of 5 shares may be used to reconstruct the secret, i.e. the threshold value is 3.

To allow any m out of n people to construct a given secret, an (m−1)-degree polynomial p(x)=a₀+a₁x+ . . . +aₘ₋₁x^{m-1} over the finite field GF(q) is constructed such that the coefficient a₀ is the secret and all other coefficients are random elements in the field. Each of the n shares is a pair (xᵢ, yᵢ) of numbers satisfying f(xᵢ)=yᵢ and xᵢ≠0. Given any m shares, the polynomial is uniquely determined and hence the secret a₀ can be computed. However, given m−1 or fewer shares, the secret can be any element in the field.

Briefly, our method encrypts a random secret key by a fingerprint image of a user and generates an object which we shall call hereinafter a “locked template”. It is important to note that our key is randomly generated rather than being generated by hashing algorithm. Our method works by reducing the fingerprint ridge pattern of a fingerprint image to a representation comprising the parameters which are the coordinates x- and y-, and the direction of flow of the ridge flow of the minutia.

A 256-bit random secret key is to be encrypted by the fingerprint template using a secure manner, such as a cryptographic algorithm which we shall now disclose. The so-encrypted locked template may be called a “fingerprint vault”, which is the registered or enrolled fingerprint against which query fingerprint images may be matched, compared or authenticated by [another] cryptographic algorithm. The presence of a genuine fingerprint, which has a ridge structure that matches the locked one, will decrypt to unlock the vault automatically, and allows the secret key to be re-generated.

Our algorithm, which for convenience shall be referred to hereinafter as the “RidgeVault™” algorithm, comprises an enrolment phase and a query phase. In the enrolment phase, a reference fingerprint image will be provided by the user to be recorded as the authorized or registered user. A secret key will be randomly generated which is to be encrypted by our algorithm according to value sets derived from the minutiae, thus creating a “locked fingerprint” or “locked template” or alternatively “fingerprint vault”. In the query phase, the algorithm will perform an automatic matching of the query fingerprint (also known as sample fingerprint) against the locked template. If the query fingerprint belongs to the genuine user i.e. matches the locked template, the secret key can be decrypted or re-generated. In other words, RidgeVault™ algorithm has been designed as a biometric cryptographic system such that given the locked fingerprint alone, it is computationally infeasible to obtain the original fingerprint information from the locked template, nor obtain the secret key from the locked template. On the other hand, given the locked template and a fingerprint image of the genuine user, the secret key can be re-generated efficiently.

By combining physical identity (biometric features) of a user with the logical identity (i.e. cryptographic keys) of that user, RidgeVault™ ties the cryptographic keys to the biometric features of the genuine user and hence addresses the non-repudiation problem in a more fundamental manner. RidgeVault™ also offers a unique process for verifying the fingerprint of a user seeking authentication against a “locked” reference fingerprint by allowing biometric information to be stored in a database in protected form and yet directly applicable for user identity verification.

Some of the salient and unique features of the RidgeVault™ algorithm include the following.

In addition to the coordinates of minutiae, it uses a threshold scheme to encrypt the random secret keys wherein the threshold scheme uses the direction information of minutiae in the key encryption and re-generation processes.

RidgeVault™ is more robust because it uses the “mean” point of the fingerprint template as a reference for selecting minutiae to encrypt the secret key which is much longer than secret keys in other algorithms.

RidgeVault™ is able to perform automatic alignment of minutiae and matching locked template against query fingerprint automatically by way of mathematical transformations.

The careful selection of parameters through well-engineered experiments allows RidgeVault™ to perform very efficiently and with highly robust matching capability. In our experiments, for example, we can generate a 256-bit random secret key within 1 second on a laptop computer.

In a general, broad embodiment of our invention, a method is provided for generating cryptographic key from biometric data comprising the steps of:
(a) acquiring a subject's biometric image and extracting characteristic features therefrom in the form of vector sets (xᵢ, yᵢ, θᵢ) comprising coordinates x and y and directional parameter θ;
(b) randomly generating a key k and applying mathematical transformation to selected vector sets to encrypt said key k, including using threshold scheme and polynomial functions in mixture with randomly generated fake vector sets to produce randomly permutated set elements of key k;
(c) constructing union of the vector sets of genuine and fake biometric data with randomly permutated set elements of key k; and
(d) forming a locked template from the union of values from step (c).

In a preferred embodiment of our invention, specific steps of our method may be provided as follows:
a) acquiring a subject's reference biometric image and extracting characteristic features therefrom;
(b) representing each of said characteristic feature as a vector, including x- and y-coordinates with a directional parameter, θ in sets of (xᵢ, yᵢ, θᵢ);
(c) selecting an Nₛ set of said vectors according to at least a predetermined criterion;
(d) randomly generating a key k;
(e) applying mathematical transformation to said selected Nₛ vector sets to encrypt said key k, including using threshold scheme, wherein a polynomial p(x) of degree D in GF(q)[X] is constructed with coefficients obtained from bit strings of said key k; wherein
   D is the degree of polynomial used by the threshold scheme for generating secret shares from k; and
   q is a prime number of sufficient bit length to cover the total bit lengths of the values of the vector set (xᵢ, yᵢ, θᵢ);
(f) constructing an integer value uᵢ of a bit length formed by the total lengths of the values of the vector set (xᵢ, yᵢ, θᵢ) by taking each of said selected vector sets Nₛ to evaluate polynomial p(x) at each of said vectors {uᵢ|1≦i≦N_{S}} to produce N_{S} pairs of value sets (u, p(u)) to form genuine set G;
(g) generating fake vectors randomly, in the same vector sets comprising x and y coordinates and a directional parameter θ, in sets of (xᵢ, yᵢ, θᵢ) and into an integer, u* of the same bit length as uᵢ;
(h) generating random value w* of the same bit length as uᵢ to form sets of M pairs with u*, i.e. in pairs of (u*, w*), referred to hereinafter as Fake Set C, wherein M is an integer which is the number of fake minutiae generated by the enrolment module;
(i) constructing Enrolled Set VS from union of G and M sets and with the randomly permutated set elements of key k;
(j) forming a locked template from the union of values VS.

One or more of the foregoing steps may preferably be embodied specifically as follows:

The selection of an Nₛ set of vectors in step (c) may comprise of computing mean position (x_{c}, y_{c}) of said vectors, given N₀ set of vectors {(xᵢ, yᵢ, θᵢ)|1≦i≦N₀}, i.e. x_{c}=(Σxᵢ/N₀) and y_{c}=(Σᵢ/N₀); sorting said vectors in ascending order of Euclidean distances from said mean position (x_{c}, y_{c}); and selecting an Nₛ set of said vectors which are closest to said mean position.

The bit lengths of xᵢ and yᵢ are each represented by 14-bit values and θᵢ is represented by a 9-bit value such that the resultant value representing the vector set is 37-bit, and wherein q is larger than 37-bit. Consequently, q is preferably the smallest prime number for the polynomial transformation to work efficiently, i.e. a 38-bit prime number; and uᵢ, u* and w* are each a 37-bit integer value.

Step (i) may immediately follow by a process step of computing a hash value of key k to obtain H(k) and wherein step (j) includes forming a locked template from the union of values VS and H(k).

The biometric image may be a fingerprint image and the characteristic features are minutiae which elements are represented in vector sets of (xᵢ, yᵢ, θᵢ) comprising coordinates x and y, and ridge flow direction of the minutia, θ. The vector elements x-coordinate and y-coordinate are preferably 14-bit integers and wherein θ is a 9-bit integer representing the direction of the minutia as an angle in the range of 1° to 360°.

The polynomial p(x) of degree D in GF(q)[X] is preferably constructed with coefficients obtained from bit strings of k, which may be a 256-bit key and is padded and split into 37-bit sub-strings K₀, K₁, K_{2,} . . . , K_{D}, to construct the polynomial p(x) of degree D in GF(q)[X] is defined as p(x)=K₀+K₁ x+K₂ x²+ . . . +K_{D} x^{D}. GF(q) may preferably be a finite field chosen for defining the polynomial so as to provide a finite field that is big enough to generate any 37-bit integer.

Each of the N_{S} minutia points (xᵢ, yᵢ, θᵢ) may be taken to construct a 37-bit integer value uᵢ=(xᵢ×2²³+yᵢ×2^{D}+θᵢ) and evaluate p(x) at each of these points {uᵢ|1≦i≦N_{S}} (said set of N_{S} pairs of (u, p(u)) are referred to hereinafter as “genuine set G”). An M number of fake vectors or minutiae may be generated randomly in at least one, in combination or all of the following criteria:
(i) each of said fake vector or minutia generated is at least a distance of Δ_{d} from any of the genuine vector or minutia points; preferably, Δ_{d} is in the range of from 7 to 10;
(ii) each of said fake vector or minutia is converted into a 37-bit integer value u* where the most significant 14 bits represents x, the next 14 bits represents y and the least significant 9 bits represents θ;
(iii) a random 37-bit value w* is generated such that w*≠p(u*)
   wherein the set of M pairs of (u*, w*) are referred to hereinafter as “fake set C”.

The Enrolled Set VS may be constructed from the union of G and M sets with the set elements randomly permutated, whereby resultant VS set contains N_{S}+M elements. N_{S} may be in the range of 25 to 45; M in the range of 200 to 400 and k is ≧256-bit, and the bit string is padded and evenly split into (D+1) substrings accordingly. D is preferably in the range of from 8 to 13.

Our foregoing method may preferably be embodied in an enrolment phase of an encryption process and further include a method for authenticating a biometric data input against said enrolled biometric image. The authenticating method may generally and broadly be described as comprising of the steps of:
(a) acquiring a subject's biometric image and extracting characteristic features therefrom;
(b) representing each of said characteristic feature in a vector, including x and y coordinates and a directional parameter θ in sets of (x_{c}, y_{c}, θ_{c}) to form Query Set Q;
(c) matching vector sets from Query Set Q with vector sets from Enrolled Set VS.

The authenticating or querying method may preferably be comprised of the following specific detailed steps of:
(a) acquiring a subject's fingerprint to be authenticated and extracting minutiae therefrom;
(b) representing each of said characteristic feature in a vector, including x and y coordinates and a directional parameter θ in sets of (x_{c}, y_{c}, θ_{c}) to form Query Set Q;
(c) computing mean position (x_{c}¹, y_{c}¹) of the query fingerprint minutiae set i.e. x_{c}¹=(Σxᵢ/N₁) and y_{c}¹=(Σyᵢ/N₁) for a given N₁ minutiae points {(xᵢ, yᵢ, θᵢ)|1≦i≦N₁};
(d) sorting query fingerprint minutiae in ascending order of Euclidean distances from the mean position (x_{c}¹, y_{c}¹) so that only N_{R} out of N₁ minutiae nearest to (x_{c}¹, y_{c}¹) will be used to form the Query Set Q to be match against the Enrolled Set VS whereby the value of N_{R} is larger than N_{S};
(e) matching minutiae in Q with minutiae in VS wherein an automatic alignment process using geometric hash table and a comparison process using some “closeness” criteria are performed, including the following process:
   (i) creating an enrolment geometric hash table T⁰ and a query geometric hash table T¹;
   (ii) computing T₀ which is a (N_{S}+M)*(N_{S}+M) matrix of transformed points in the Enrolled Set, VS, and for each of the points in VS,
   (iii) using this point as the “basis” to transform all other points in the VS, wherein the transformation uses the basis as the new origin and it's orientation as the new x-axis) so that, given a minutia mⱼ=(xⱼ, yⱼ, θⱼ) to be transformed using another minutia mᵢ=(xᵢ, yᵢ, θᵢ) as the basis, the transformation is computed using the following equation:

$${m}_{j} ( i ) = ( \begin{matrix}\begin{matrix}{x}_{j} ( i ) \\ {y}_{j} ( i )\end{matrix} \\ {θ}_{j} ( i )\end{matrix} ) = ( \begin{matrix}cos ( {θ}_{i} ) & sin ( {θ}_{i} ) & 0 \\ - sin ( {θ}_{i} ) & cos ( θ i ) & 0 \\ 0 & 0 & 1\end{matrix} ) ( \begin{matrix}{x}_{j} - {x}_{i} \\ {y}_{j} - {y}_{i} \\ {θ}_{j} - θ i\end{matrix} )$$

(iv) adjusting the transform equation according to the representation convention of the direction of minutiae, θᵢ in the transform equation above, by replacing it with αᵢ which is defined in terms of θᵢ by letting αᵢ be the degree representing the direction of minutia i rotating from the x-axis to the y-axis, and compute αᵢ with respect to the definition of θᵢ as follow:
   αᵢ=θᵢ if θᵢ is the angle of minutia i measured from x-axis to y-axis;
   αᵢ=−θᵢ if θᵢ is the angle of minutia i measured from x-axis to negative y-axis;
   αᵢ=180−θᵢ if θᵢ is the angle of minutia i measured from negative x-axis to y-axis;
   αᵢ=180+θᵢ if θᵢ is the angle of minutia i measured from negative x-axis to negative y-axis;
   αᵢ=90−θᵢ if θᵢ is the angle of minutia i measured from y-axis to x-axis;
   αᵢ=90+θᵢ if θᵢ is the angle of minutia i measured from y-axis to negative x-axis direction;
   αᵢ=270+θᵢ if θᵢ is the angle of minutia i measured from negative y-axis to x-axis; and
   αᵢ=270−θᵢ if θᵢ is the angle of minutia i measured from negative y-axis to x-axis;
(v) repeating step (e)(iv) using each of the points in VS as a basis so that each row of the matrix is a transformed VS of (N_{S}+M) points and there are (N_{S}+M) such transformations, wherein given a minutiae set VS={m₁, m₂, . . . , m_{N}}, iteratively taking a minutia mᵢ in VS (1≦i≦N) as basis to transform VS to compute Tᵢ as follows

$$T i = [ \begin{matrix}{x}_{1} ( i ) & {y}_{1} ( i ) & {θ}_{1} ( i ) \\ {x}_{2} ( i ) & {y}_{2} ( i ) & {θ}_{2} ( i ) \\ ⋮ & ⋮ & ⋮ \\ {x}_{N} ( i ) & {y}_{N} ( i ) & {θ}_{N} ( i )\end{matrix} ]$$

and resulting in a set of N transformed minutiae sets

$$T = [ \begin{matrix}{T}_{1} \\ {T}_{2} \\ ⋮ \\ {T}_{N}\end{matrix} ]$$

wherein T is the geometric hash table of VS;
(vi) computing T¹ as a transformation of the N_{R} minutiae in Q which are transformed in the way as for T⁰, i.e. a N_{R}*N_{R} matrix of transformed points in Q whereby each row of the matrix is a transformed Q of N_{R} points and there are N_{R} such transformations;
(f) given T⁰ and T¹, taking one row of T⁰ and iteratively comparing its points with the points in each of the rows of T¹. Let (xₐ, yₐ, θₐ) be a point in Tₐ⁰ and (x_{b}, y_{b}, θ_{b}) be a point in T_{b}¹, count the number of pairs that satisfy the following closeness criteria Δ¹: (xₐ−x_{b})²+(yₐ−y_{b})²≦Δᵢ² AND |θₐ−θ_{b}|≦Δ_{θ} OR (360−|θₐ−θ_{b}|)≦Δ_{θ};
(g) repeating aforesaid comparison process for all rows of T⁰ and T¹ and keeping track of the rows of T⁰ and the rows of T¹ having at least D+1 transformed minutiae pairs which satisfy the closeness criteria wherein
   (i) let Tᵢ⁰ be the row of T⁰ and Tⱼ¹ be the row of T¹ that satisfy these criteria, proceeding to the next step;
   (ii) if no such pair exist, then exit the query module and matching failed;
(h) let there be K points in Tᵢ⁰ and Tⱼ¹ that satisfy the closeness criteria, identifying these K points in Tᵢ⁰ to form the query point set where each of the points is a pair (uᵢ, vᵢ);
(i) choosing any D+1 points out of the K point from the query point set, and using them to interpolate a polynomial p*(x) of degree D, wherein a highly optimized method is used to implement this, or alternatively, a simple interpolation equation for a given set of points LS={(v₁,w₁), (v₂,w₂), . . . ,(v_{D+1},w_{D+1})} as follows is used:

$${p}^{*} ( u ) = \frac{( u - {v}_{2} ) ( u - {v}_{3} ) … ( u - {v}_{D + 1} )}{( {v}_{1} - {v}_{2} ) ( {v}_{1} - {v}_{3} ) … ( {v}_{1} - {v}_{D + 1} )} {w}_{1} + \frac{( u - {v}_{1} ) ( u - {v}_{3} ) … ( u - {v}_{D + 1} )}{( {v}_{2} - {v}_{1} ) ( {v}_{2} - {v}_{3} ) … ( {v}_{2} - {v}_{D + 1} )} {w}_{2} + … + \frac{( u - {v}_{1} ) ( u - {v}_{2} ) … ( u - {v}_{D} )}{( {v}_{D + 1} - {v}_{1} ) ( {v}_{D + 1} - {v}_{2} ) … ( {v}_{D + 1} - {v}_{D} )} {w}_{D + 1}$$

(j) concatenating the D+1 coefficients of p*(x) to form a key string k* and computing the hash value H(k*);
(k) matching if H(k)=H(k*), if matched then k* is the secret key and returns k*, alternatively, if H(k)≠H(k*), then try another (D+1)-subset of the query point set until H(k)=H(k*) is satisfied.

Our aforesaid methods may be implemented in respect of other biometric data such as an iris image wherein the directional parameter θ is substituted with r where r is increasing radius, so that the vector set may be represented as (xᵢ, yᵢ, rᵢ). Our method may be implemented in an automated electronic process, including as an executable in computer-implemented process, in for example a biometric authentication system incorporated in a device or apparatus.

### DETAILED DESCRIPTION OF PREFERRED EMBODIMENT

In broad, general terms, our invention may be briefly described as a method for generating cryptographic key from biometric data wherein a subject's biometric image is acquired whereby characteristic features from the image are extracted and represented in vector sets, each set including coordinates x and y and a directional parameter θ, the vector set format in form of (xᵢ, yᵢ, θᵢ). Next, fake biometric characteristic features are generated and represented in the same vector set form.

A secret key is randomly generated. Mathematical transformation is then applied, including threshold scheme, to the combined vector sets of said biometric image and fake biometric vector sets, using threshold scheme to encrypt the randomly generated key into a representation which we would call a “locked template”. It should be noted that, in contrast with the prior art biometric cryptography methods, we do not use hashing algorithm to generate keys. Instead, we use threshold scheme to encrypt a randomly generated key from the biometric data. The representation may be in the form of numeric, alphanumeric or graphic representation such as barcodes, including 2-dimensional (matrix) barcodes.

The embodiment described in detail in the following uses fingerprint as an example of the biometric data to be processed in accordance with our invention. It should be noted that our scheme proposed may be implemented for any feature-based biometric algorithm, just as the present example of taking minutiae as the feature of fingerprints, wherein the feature may be represented by a vector (i.e. inclusive of a directional parameter in addition to x- and y-coordinates).

In terms of process, our invention, as represented by the RidgeVault™ process, in particular, the algorithm, may be divided into enrolment phase and a query phase. During the enrolment phase, a reference fingerprint image will be provided by a user who is to be registered as an authorised user. In the query phase, a query fingerprint will be provided by the query user. If the query fingerprint is genuine, i.e. matches the reference fingerprint, the secret key can be decrypted and re-generated. For robustness consideration, the secret key will be re-generated if the reference fingerprint and the query fingerprint match up to a “threshold” number of minutiae.

### The Enrolment Phase

To ensure the quality of the input fingerprint image provided to the RidgeVault™ algorithm, the enrolment module typically requires the user to provide more than one reference fingerprint images. The enrolment module then extracts minutiae from all the images provided, and choose minutiae according to some robustness criteria. The process of extracting fingerprint minutiae (x, y, θ) from ridge structures of the input fingerprint images may usually be implemented with the application programming interface (API) of the scanner in which conventional technology may be used, such as optical imaging, ultrasonic sensing or capacitance sensing.

As an overview, our RidgeVault™ procedure may be described as a method for generating cryptographic key from biometric data comprising the steps of, firstly, acquiring a subject's biometric image and extracting characteristic features therefrom, such as fingerprint minutiae.

Secondly, each of the characteristic feature is then represented as a vector including x and y coordinates with a directional parameter, θ in sets of (xᵢ, yᵢ, θᵢ). Given No minutiae points {(xᵢ, yᵢ, θᵢ)|1≦i≦N₀}, the mean position (x_{c}, y_{c}) of the reference fingerprint minutiae set is computed, i.e. x_{c}=(Σxᵢ/N₀) and y_{c}=(Σyᵢ/N₀). The reference fingerprint minutiae may then be sorted in ascending order of Euclidean distances from (x_{c}, y_{c}). A set of N_{S} minutiae (out of the N₀ minutiae) which are closest to the mean position are then chosen. This set of N_{S} minutiae is used for encrypting the secret key k. Preferably, the x- and y-coordinate are each 14-bit, while θ is 9-bit.

A key k randomly generated and to be encrypted by the said vector sets. A polynomial p(x) of degree D in GF(q)[X] may then be constructed with coefficients obtained from bit strings of said key k; wherein

D is the degree of polynomial used by the threshold scheme for generating secret shares from k, preferably in the range of 8 to 13; and

q is a 38-bit prime number; preferably q is the smallest 38-bit prime number. It should be noted that the bit length of the prime number is determined by the bit length of the (xᵢ, yᵢ, θᵢ) values, i.e. with x and y being 14-bit and θ being 9-bit, the resultant prime number would be 37-bit. The prime number needs to be larger than 37-bit in order for the mathematical processes to work. Thus, RidgeVault™ may use any length larger than 37; nevertheless, the efficiency of the algorithm is partly determined by the size of the prime number, hence, it will be inefficient if the length of the prime number is larger than necessary and accordingly it will be most efficient if the smallest prime number is taken, i.e. 38-bit.

Preferably, k is 256-bit and for k values with less than 256 bits, the bit string may evenly be split into D+1 substrings accordingly. For example, let k be a 256-bit key denoted by the bit string of k₀, k₁, k₂, . . . , k₂₅₅ and let degree of polynomial be 9 i.e. D=9. In this example, the 256-bit key k is split into 26-bit sub-strings K₀, K₁, . . . , K₉, and the polynomial p(x) of degree 9 in GF(q)[X] is defined as p(x)=K₀+K₁x+K₂x²+ . . . +K₉x⁹.

Note that the finite field GF(q) is chosen for defining the polynomial because the algorithm needs a finite field that is big enough to generate any 37-bit integer.

An alternative, more general approach to splitting the key string and constructing the polynomial of degree 9 is as follows: Generate a random string of 37×(D+1)=370 bits by padding the 256-bit key k with 114 random bits. Note that 37 is less than the size in bits of q in GF(q)[X]. Evenly split the string into D+1 substrings (each of 37 bits) accordingly and use them as the coefficients of the polynomial p(x) as before.

Secret key k is firstly padded to make the length a multiple of (D+1) with random bits (k₂₅₆, . . . , k₂₅₉), and the padded key is stored as an array of D+1 integers as follows:

K₀=k[0]=k₀, k₁, . . . , k₂₅

K₁=k[1]=k₂₆, k₂₇, . . . , k₅₁

and

K₈=k[8]=k₂₀₈, k₂₀₉, . . . , k₂₃₃

K₉=k[9]=k₂₃₄, k₂₃₅, . . . , k₂₅₉.

Next, each of said vector sets, i.e. N_{S} minutiae points (xᵢ, yᵢ, θᵢ), is taken to construct 37-bit integer value uᵢ where

uᵢ=(xᵢ×2²³+yᵢ×2⁹+θᵢ)

and p(x) is evaluated at each these vectors, {uᵢ|1≦i≦N_{S}} to produce N_{S} pairs of value sets (u, p(u)) to form genuine set G. Hence, N_{S} may be taken to represent an integer which is the number of genuine minutiae for encrypting secret key k. Preferably, N_{S} is in the range of 25 to 45. It may be explained here that power 9 is the bit length of the angle θ since 9 bits is required to represent 0° to 359° values. Power 23 is (9+14) where 14 is the bit length of the y-coordinate, i.e. left shift the y-coordinate by 9 bits and left shift the x-coordinate by 23 bits. In essence, we are concatenating the three bit strings of the three values x, y and θ into one 37-bit integer.

Subsequently, fake vectors are generated randomly, in the same x and y coordinates and a directional parameter θ, in sets of (xᵢ, yᵢ, θᵢ) and into a 37-bit integer, u* where preferably, the most significant 14 bits represents x, the next 14 bits represents y and the least significant 9 bits represents θ.

The randomly generated set M of fake minutiae should preferably satisfy the condition that they are not too close to any genuine minutiae i.e. with a minimum Euclidean distance of at least Δ_{d} from any of the genuine points. Preferably, M is in the range of 200 to 400 while the preferred value of Δ_{d} ranges from 7 to 10.

Thereafter, random 37-bit value w* are generated such that w*≠p(u*) to form sets of M pairs with u*, i.e. pairs of (u*, w*) which may be called Fake Set C. M may be taken as an integer which is the number of fake minutiae generated by the enrolment module to be processed with the genuine minutiae set G.

The next step comprises constructing Enrolled Set VS from union of the aforesaid G and M sets and with the set elements randomly permutated. As a result of the union operation, VS contains N_{S}+M elements.

A hash value of key k is then computed to obtain H(k). A standard hash function such as MD5 and SHA-1 may be used. For example, MD5 produces 128-bit hash value while SHA-1 produces 160-bit hash value. It should be noted that such hash functions are employed in our algorithm to verify the values of the key re-generated in the Query Phase (to be described in the following) of our RidgeVault™ algorithm. The cryptographic key is then formed from the values VS as a result of a successful query against enrolled values rather than as an output of enrolment.

To summarise, the enrolment phase comprises 2 main operations: random generation of the secret key, and encryption of the secret key using the user's fingerprint features or minutiae. In other words, the secret key is generated randomly in the enrolment phase and is then encrypted by an algorithm that is determined by minutiae to form a “locked template”. The same secret key is then regenerated in the query phase by a genuine fingerprint. Hence, from the perspective of protection of the randomly generated secret key, the enrolment phase can be viewed as the encryption process and the query phase the decryption process.

### The Query Phase: Unlocking the Ridge Vault to Re-Generating Secret Key

The Query Phase of our invention is essentially unlocking the RidgeVault™ secret key automatically when the correct biometric data is provided so that the secret key is re-generated from the locked template (which is represented by VS) in the decryption process. By way of mathematical transformation, the RidgeVault™ query module may automatically perform matching between a query fingerprint and the locked template which has been generated previously with the enrolled fingerprint of the genuine or authorised person. If the query fingerprint is from the genuine user, the correct secret key k will be decrypted and re-generated by the query module. Likewise, the query module verifies the identity of the query user if the secret key is re-generated correctly.

Like the enrolment parameters, x-coordinate and y-coordinate are preferably 14-bit integers, and θ is a 9-bit integer which represents the direction of the minutia as an angle in the range of 1° to 360°.

Given a query fingerprint image, a set of minutiae points {(xᵢ, yᵢ, θᵢ)|1≦i≦N₁} are extracted. The minutiae extraction function is usually available from the API of the fingerprint scanner since we are using conventional biometric scanning methods and devices, just as in the Enrolment Phase described above. This set of minutiae points is passed as an input parameter to the query module for matching against the Enrolled Set, VS. Given that the cryptographic key is then re-generated from the vector set (VS) and verified by the value H(k)), the Query Module may be described as follows:

Given N₁ minutiae points extracted from the query fingerprint images, {(xᵢ, yᵢ, θᵢ)|1≦i≦N₁}, the mean position (x_{c}¹, y_{c}¹) of the query fingerprint minutiae set is computed, i.e.

x_{c}¹=(Σxᵢ/N₁) and y_{c}¹=(Σyᵢ/N₁).

The Query fingerprint minutiae is then sorted in ascending order of Euclidean distances from the mean position (x_{c}¹, y_{c}¹) so that only N_{R} out of N₁ minutiae nearest to (x_{c}¹, y_{c}¹) will be used to form the Query Set Q. The query set will be used to match against the Enrolled Set VS. Note that the value of N_{R} is typically chosen to be larger than N_{S}, e.g. N_{R}=30 and N_{S}=25. Preferably, N_{R} is in the range from 30 to 50.

The minutiae in Q is then matched with minutiae in VS. To achieve this, an automatic alignment process, for example, using geometric hash table and a comparison process using some “closeness” criteria, may be performed. Hence, the matching starts with the creation of the enrolment geometric hash table T⁰ and a query geometric hash table T¹.

The geometric hash table T₀, which is a (N_{S}+M)*(N_{S}+M) matrix of transformed points in the Enrolled Set, VS, is first computed. For each of the points in VS, this point is used as the “basis” to transform all other points in the VS set. The transformation uses the basis as the new origin and it's orientation as the new x-axis as follows:

Given a minutia mⱼ=(xⱼ, yⱼ, θⱼ) to be transformed using another minutia mᵢ=(xᵢ, yᵢ, θᵢ) as the basis, the transformation is computed using the following equation:

$${m}_{j} ( i ) = ( \begin{matrix}{x}_{j} ( i ) \\ {y}_{j} ( i ) \\ {θ}_{j} ( i )\end{matrix} ) = ( \begin{matrix}cos ( {θ}_{i} ) & sin ( {θ}_{i} ) & 0 \\ - sin ( {θ}_{i} ) & cos ( θ i ) & 0 \\ 0 & 0 & 1\end{matrix} ) ( \begin{matrix}{x}_{j} - {x}_{i} \\ {y}_{j} - y i \\ {θ}_{j} - θ i\end{matrix} )$$

This equation has the effect of transforming mⱼ using (xᵢ, yᵢ) as the new origin and using the orientation of θᵢ for the new x-axis. Depending on the representation convention of the direction of minutiae, the transform equation to be applied may be adjusted. To generalize, the transform to cater for different convention of the minutiae angles, θᵢ in the transform equation above is replaced with αᵢ which is defined in terms of θᵢ as follows.

Let αᵢ be the degree representing the direction of minutia i rotating from the x-axis to the y-axis. We may then compute αᵢ with respect to the definition of θᵢ as follow:
i. αᵢ=θᵢ if θᵢ is the angle of minutia i measured from x-axis to y-axis.
ii. αᵢ=−θᵢ if θᵢ is the angle of minutia i measured from x-axis to negative y-axis.
iii. αᵢ=180−θᵢ if θᵢ is the angle of minutia i measured from negative x-axis to y-axis.
iv. αᵢ=180+θᵢ if θᵢ is the angle of minutia i measured from negative x-axis to negative y-axis.
v. αᵢ=90−θᵢ if θᵢ is the angle of minutia i measured from y-axis to x-axis.
vi. αᵢ=90+θᵢ if θᵢ is the angle of minutia i measured from y-axis to negative x-axis direction.
vii. αᵢ=270+θᵢ if θᵢ is the angle of minutia i measured from negative y-axis to x-axis.
viii. αᵢ=270−θᵢ if θᵢ is the angle of minutia i measured from negative y-axis to x-axis.

This process is repeated using each of the points in VS as a basis. Thus, each row of the matrix is a transformed VS of (N_{S}+M) points and there are (N_{S}+M) such transformations. That is, given a minutiae set VS={m₁, m₂, . . . , m_{N}}, iteratively take a minutia mᵢ in VS (1≦i≦N) as basis to transform VS to compute Tᵢ as follows

$$T i = [ \begin{matrix}{x}_{1} ( i ) & {y}_{1} ( i ) & {θ}_{1} ( i ) \\ {x}_{2} ( i ) & {y}_{2} ( i ) & {θ}_{2} ( i ) \\ ⋮ & ⋮ & ⋮ \\ {x}_{N} ( i ) & {y}_{N} ( i ) & {θ}_{N} ( i )\end{matrix} ]$$

hence resulting in a set of N transformed minutiae sets

$$T = [ \begin{matrix}{T}_{1} \\ {T}_{2} \\ ⋮ \\ {T}_{N}\end{matrix} ]$$

where T is the geometric hash table of VS.

T¹ may then be computed as a transformation of the N_{R} minutiae in Q which are transformed in the same way as for the one for T⁰. Thus it is a N_{R}*N_{R} matrix of transformed points in Q, i.e. each row of the matrix is a transformed Q of N_{R} points and there are N_{R} such transformations.

To start the comparison process, given T⁰ and T¹, one row of T⁰ is taken and its points are iteratively compare with the points in each of the rows of T¹. Let (xₐ, yₐ, θₐ) be a point in Tₐ⁰ and (x_{b}, y_{b}, θ_{b}) be a point in T_{b}¹; the number of pairs that satisfy the closeness criteria Δ¹ are counted, i.e.

(xₐ−x_{b})²+(yₐ−y_{b})²≦Δᵢ² AND i.

|θₐ−θ_{b}|≦Δ_{θ} OR (360−|θₐ−θ_{b}|)≦Δ_{θ} ii.

in which Δ¹ is the closeness criteria comprising (Δᵢ, Δ_{θ}) where Δᵢ is a real number which specifies the threshold distance within which two minutiae coordinates are considered “close”, and Δ_{θ} is the angle within which two minutiae angles are considered “close”. Preferably, Δ¹ is defined by Δᵢ and Δ_{θ} with Δᵢ ranges between 5 to 7 and Δ_{θ} between 12.5 to 22.5.

This comparison process is repeated for all rows of T⁰ and T¹. Keep track of the rows of T⁰ and the rows of T¹ that have at least D+1 transformed minutiae pairs which satisfy the closeness criteria. Let Tᵢ⁰ be the row of T⁰ and Tⱼ¹ be the row of T¹ that satisfy these criteria, then proceed to the next step. If no such pair exist, then exit the query module and matching failed.

Let there be K points in Tᵢ⁰ and Tⱼ¹ that satisfy the closeness criteria, the next step is to identify these K points in Tᵢ⁰ to form the query point set where each of the points is a pair (uᵢ, vᵢ).

Any D+1 points are chosen out of the K point from the query point set, whereby they are used to interpolate a polynomial p*(x) of degree D in GF(q)[X]. As in the case of q in the enrolment phase, q in the query phase is preferably the smallest 38-bit prime number.

Although we use a highly optimized method to implement this, as an example, a simple interpolation equation for a given set of points LS={(v₁,w₁),(v₂,w₂), . . . ,(v_{D+1},w_{D+1})} may also be implemented as follows:

$${p}^{*} ( u ) = \frac{( u - {v}_{2} ) ( u - {v}_{3} ) … ( u - {v}_{D + 1} )}{( {v}_{1} - {v}_{2} ) ( {v}_{1} - {v}_{3} ) … ( {v}_{1} - {v}_{D + 1} )} {w}_{1} + \frac{( u - {v}_{1} ) ( u - {v}_{3} ) … ( u - {v}_{D + 1} )}{( {v}_{2} - {v}_{1} ) ( {v}_{2} - {v}_{3} ) … ( {v}_{2} - {v}_{D + 1} )} {w}_{2} + … + \frac{( u - {v}_{1} ) ( u - {v}_{2} ) … ( u - {v}_{D} )}{( {v}_{D + 1} - {v}_{1} ) ( {v}_{D + 1} - {v}_{2} ) … ( {v}_{D + 1} - {v}_{D} )} {w}_{D + 1}$$

The D+1 coefficients of p*(x) may be concatenated to form a key string k*. The correctness of the re-generated key k* is verified by computing the value H(k*). If H(k)=H(k*), then the secret key is correctly re-generated and returns k*. If H(k)≠H(k*), then try another (D+1)-subset of the query point set until H(k)=H(k*) is satisfied. Preferably, degree of polynomial D is from 8 to 13, as in the enrolment phase.

It should be noted that the secret keys in RidgeVault™ are randomly generated. The hash function used in RidgeVault™ is not for generating keys; instead it is an optional step used for obtaining a summary of the already generated key. The fake minutiae points in the locked template is not used in the key generation process.

To summarise, the enrolment phase basically perform 2 tasks: random generation of the secret key and encryption of the secret key using the user's fingerprint features. The secret key is generated randomly in the enrolment phase and is encrypted by the fingerprint to form the locked template. The same secret key is regenerated in the query phase by a genuine fingerprint presented. Hence, from the perspective of protection of the randomly generated secret key, the enrolment phase can be viewed as the encryption process wherein the secret key is locked, and the query phase is the decryption process wherein the secret key is unlocked.

### Implementation of the RidgeVault Algorithm

To implement the RidgeVault™ algorithm, we use APIs from fingerprint scanner software to perform the following:
1. Capture fingerprint image.
2. Extract minutiae from the fingerprint image which has representation of the format (x, y, θ).
3. Access individual fields in a minutiae structure.

Besides the foregoing, a number of auxiliary functions are required to facilitate manipulation of the minutiae and secret key strings. For example, the following are useful functions.

GenRandom ()
Input

Int bit_length

Output

char []

Generates a random number of the specified length.
E.g. 256-bit keys, 37-bit fake points and 37-bit values for fake points.
SplitKey2Coeff ()
Input

*char bit_string, str_length, coeff_length

Output

Int, Int []

Splits a bit string to an array of coefficients of the specified length.
ConvertMinutia2Int ()
Input

Minutiae/* struct (x, y, θ) */

Output

Int

Convert a minutia point (x, y, θ) to an integer by
concatenating the 14-bit x-axis, 14-bit y-axis
and 9-bit orientation to a 37-bit integer.
ConvertInt2Minutia ()
Input

Int

Output

Minutiae

Split a 37-bit integer into substrings and represent
them as a minutiae point (x, y, θ).
EuclidDistance ()
Input

Coord, Coord

Output

Int

Compute the Euclidean distance of two points in the x-y plane.
TestCloseness ()
Input

Minutiae, Minutiae , Delta

Output

Boolean

Given two minutiae mᵢ, = (xᵢ, yᵢ, θᵢ),
mⱼ = (xⱼ, yⱼ, θⱼ) and a closeness range Δ = (Δₓ, Δ_{y}, Δₑ),
determine whether the closeness of mᵢ and mⱼ are
within the given range Δ. i.e.
If

(Xₐ − X_{b})² + (yₐ − y_{b})² ≦ Δᵢ² AND
|θₐ − θ_{b}| ≦ Δₑ OR (360 − |θₐ − θ_{b}|) ≦ Δₑ

then True else False.
ConstructPolyX ()
Input

Int []

Output

PolyX/* an array of coefficients of the polynomial */

Given D+1 coefficients, construct a polynomial of degree D
and represent it in a structure that facilitate polynomial evaluation.
InterpolatePolyX ()
Input

Int []

Output

PolyX

Given D+1 points in GF(q), interpolate a polynomial in
GF(q)[X] of degree D and represent it
in a structure that facilitate access of coefficients.
EvalPolyX ()
Input

PolyX, Int

Output

Int

Evaluate polynomial p(x) for a specified value of x.
SortMinutiae ()
Input

Coord, *Minutiae

Output

*Minutiae

Sort a list of minutiae in ascending order of their Euclidean
distance from the mean position.
Given the list of minutiae, compute the mean position and the
Euclidean distance of each minutiae from the mean position,
then sort the minutiae in ascending order of their Euclidean
distance from the core.
TransformMinutiae ()
Input

Minutiae, Minutiae

Out

Minutiae

Given a minutia mⱼ = (xⱼ, yⱼ, θⱼ) to be
transformed using another minutia mᵢ = (xᵢ, yᵢ, θᵢ) as the
basis. The transformation is computed using the following equation:

${m}_{j} ( i ) = ( \begin{matrix}{x}_{j} ( i ) \\ {y}_{j} ( i ) \\ {θ}_{j} ( i )\end{matrix} ) = ( \begin{matrix}cos ( {θ}_{i} ) \\ - sin ( {θ}_{i} ) \\ 0\end{matrix} \begin{matrix}sin ( {θ}_{i} ) \\ cos ( θi ) \\ 0\end{matrix} \begin{matrix}0 \\ 0 \\ 1\end{matrix} ) ( \begin{matrix}{x}_{j} - {x}_{i} \\ {y}_{j} - yi \\ {θ}_{j} - θi\end{matrix} )$

This equation has the effect of transforming mⱼ using
(xᵢ, yᵢ) as the new origin and using the
orientation of θᵢ for the new x-axis.
TransformMinutiaeSet ()
Input

*Minutiae, Minutiae

Output

*Minutiae

Given a minutiae set VS = {m₁, m₂, . . . , m_{N}}and
a minutia mᵢ as basis, for each point mⱼ in VS
(1 ≦ j ≦ N), transform the point with respect
to mᵢ i.e. TransformMinutiae(mⱼ, mᵢ) The set of
transformed points Tᵢ is as follows:

$T i = [ \begin{matrix}{x}_{1} ( i ) & {y}_{1} ( i ) \\ {x}_{2} ( i ) & {y}_{2} ( i ) \\ ⋮ & ⋮ \\ {x}_{N} ( i ) & {y}_{N} ( i )\end{matrix} \begin{matrix}{θ}_{1} ( i ) \\ {θ}_{2} ( i ) \\ ⋮ \\ {θ}_{N} ( i )\end{matrix} ]$

SortTransformedSet ()
Input

*Minutiae

Output

*Minutiae, *Int

Given a set of transformed minutiae points, sort the minutiae
in ascending order of their value of x-axis.
CreateGeometricHashTable ()
Input

*Minutiae

Output

**Minutiae

Given a minutiae set VS = {m₁, m₂, . . . m_{N}}.
Iteratively take a minutia mᵢ in VS (1 ≦ i ≦ N) as
basis to transform VS i.e. Tᵢ = TransformMinutiaeSet(VS, mᵢ),
hence resulting in a set of N transformed minutiae sets

$T = [ \begin{matrix}{T}_{1} \\ {T}_{2} \\ ⋮ \\ {T}_{N}\end{matrix} ]$

T is the geometric hash table of VS.

### Examples of Applications

There are many important areas where the RidgeVault™ algorithm can be applied. For example:
Generation of secret keys for supporting encryption and decryption of files and data.
Used in mobile devices for storing secret keys in an insecure environment. The secret key may be used for supporting mobile commerce transactions.
Supporting identity verification when a system needs to match a query fingerprint against a reference fingerprint stored in a protected manner.
Implementation of secure and efficient checklist screening on databases of suspected persons or offenders.

It should be noted that the Enrolment Module is performed only once to generate the random secret key and to create the locked template, using the fingerprint to encrypt the secret key in a secure manner. The Query Module is executed whenever the secret key is needed, e.g. to regenerate the secret key to encrypt file as well as to re-generate the secret key to decrypt the encrypted file. In implementing our invention in applications such as the following examples, it is important to note the distinction between the encryption and decryption of the secret key using fingerprint and the encryption and decryption of files using the re-generated secret key.

Some of these applications are outlined in the following.

### Example 1

### Seamless Generation of Secret Key for File/Data Encryption

Security is a key issue in e-government and e-commerce application systems. Electronic transactions processed by such systems need to be protected cryptographically. For example, a e-government transaction submitted by a citizen to the e-government application system needs to be encrypted for confidentiality of the data and accountability of the users. Cryptographic operations require the use of secret keys which are hard to manage in large scale network applications. The use of public key infrastructure (PKI) is one feasible solution. Unfortunately, the cost of deployment has proven to be prohibitive factor for the widespread adoption of PKI.

With the use of RidgeVault™, users will be able to store the secret key in protected form i.e. the locked template, and the secret key can be re-generated when needed by the user as a result of matching with a genuine fingerprint. The process may be implemented as follows:
(a) e-Government server sends a login page to the user. The login page comes with a random number (for use in challenge-response authentication).
(b) Upon receiving the login page, user provides fingerprint image to the RidgeVault algorithm which matches and re-generate the secret key.
(c) The secret key is used to encrypt the user ID together with the random challenge in order to produce an authentication response.
(d) The authentication response is sent back to the e-government server which uses its copy of the secret key for decryption and verification of the random challenge. If the decrypted value is correct, the server confirms that it is communicating with the authentic user who is able to generate the secret key from the locked template.

Besides the use of secret key for on-line transactions, the RidgeVault™ algorithm can also be used by users to encrypt/decrypt files in a convenient manner. A typical flow may be as follows:
1. User prepared a file containing sensitive information to be stored at the local hard disk.
2. User runs the RidgeVault™ algorithm to generate the secret key by providing a genuine fingerprint.
3. The secret key is used to encrypt the sensitive file before it is stored at the hard disk.
4. At a later stage when the user need to retrieve and open the file, he runs the RidgeVault™ algorithm again and uses his fingerprint to re-generate the secret key which is in turn used to decrypt the sensitive file.
5. The sensitive file is available to the user after decryption.

It should be noted that the enrolment module is allowed to run only once to generate the random secret key and to create the locked template which embedded the secret key in a secure manner. The query module is allowed to run whenever the secret key is needed, e.g. to re-generate the secret key to encrypt file as well as to re-generate the secret key to decrypt the encrypted file. As shown in this example, it is important to note the different operations of our RidgeVault™ algorithm in respect of:
encryption/decryption of the secret key using fingerprint; and
encryption/decryption of files using the re-generated secret key.

### Example 2

### Secure Storage of Secret Key in Insecure Mobile Device

Mobile commerce is a most prominent area of growth in the ICT industry due to the high penetration of mobile network and mobile communicating devices. However, because of the open nature of mobile communication channels, mobile commerce transactions require strong security assurance before its potential can be fully realized. The protection of mobile transaction is challenging because of the inherently insecure environment of mobile devices.

The use of encryption on a mobile device will require secret keys to be stored inside the device. However, the secret key may be compromised if the mobile phone is lost or stolen. Thus resulting in unmanageable lost to the phone owner. On the other hand, the use of security hardware for storing secret key in mobile devices will inevitably add significant costs to the mobile devices which will in turn prohibit the adoption of mobile commerce. Therefore, some kind of cost-efficient way to securely store the secret key on a mobile device is of great demand in the promotion of mobile commerce.

In this connection, RidgeVault™ is an ideal mechanism which allows a locked template to be stored in a low cost fingerprint scanner-enabled mobile phone. When the user needs to execute mobile transactions, he simply swipe his finger over the low cost fingerprint scanner of the phone. With genuine fingerprint information, the RidgeVault™ algorithm will be able to unlock the stored fingerprint and re-generate the secret key which can then be used for protecting the mobile transactions.

A mobile phone stored with private and confidential data may be stolen and the private data inside can be easily compromised and the content may be indiscriminately distributed over the Internet. The use of RidgeVault™ mechanism can also help prevent such scenario by using the secret key to encrypt the data which are stored in the mobile phone. Should the genuine phone owner want to open the data files, he simply swipes his finger over the fingerprint scanner of the phone which will then runs the RidgeVault™ algorithm to re-generate the secret key for decrypting the data files.

The security features of the locked template make it extremely difficult for attackers to re-generate the key to execute fraudulent transactions or to decrypt confidential files stored in the phone.

### Example 3

### Secure and Efficient Checklist in Personnel Screening

In national security applications such as personnel screening and immigration checkpoints, the process of screening individuals against a list of prohibited or black-listed persons is of critical importance to national security, for example to detect travellers with previous illegal entry/stay records and criminals in wanted list. The lists are usually prepared at one location by some law-enforcement agency and distributed to remote control points for people screening. Nevertheless, the target lists are difficult to handle because of the high sensitivity and wide distribution of the information. The target list is almost invariably classified at least at “secret” level, and yet needs to be distributed to a lot of locations in order to facilitate screening at remote control points. At the same time, in order to enhance the accuracy of the screening process, more unique information about the target people need to be included in the checklists. Therefore, national security application systems need to address the challenging requirements of checklist screening:
Checklists should be distributed to a lot of locations conveniently.
Checklists must be protected against illegal disclosure of their contents.
Checklists should capture more comprehensive information about the target individuals in order to enhance robustness of the screening process. In essence, information that describe unique characteristics of the individuals need to be included. For example, biometric data such as fingerprint and facial images of the target person may be included in the checklist.
Checklists screening must be performed efficiently so that screening at control points with heavy passenger throughput will not jeopardize business operations of the control points.

RidgeVault™ is an ideal solution to solve these multitude of challenges faced by state-of-the-art national security application systems. With RidgeVault™ adopted by national security applications, the checklist may be replaced with the list of hashed key of the target individuals. As such,
The target individual is uniquely identified by the fingerprint biometric which is tied to the secret key, hence the hash value of the key; thus addressed the robustness requirement of the screening;
The hash value does not disclose any information about the target individual, hence addressed the confidentiality requirement of the checklist;
A person to be screened will be asked to go through the RidgeVault™ query process to re-generate the secret key. The screening can be performed by comparing the hash value of the re-generated key against the list of hash values in the target list.

Instead of going through physical biometric matching, which is time consuming, RidgeVault™-based screening is a process of comparing integer values which can be performed very efficiently and accurately by a computerised system.

### Example 4

### Locked Template for Biometric Verification

In most national security related systems, fingerprint biometric information need to be stored in a database which allows application systems to verify identity of some individuals by performing fingerprint matching against the database records. However, recent enactment of personal privacy legislation in some countries, e.g. Hong Kong and Japan which adopted the OECD Guidelines on the Protection of Privacy and Transborder Flows of Personal Data, require that personal data especially biometric data be carefully handled and properly protected when stored in computer systems.

One possible approach to comply this requirement is to store biometric data in encrypted form. However, this approach not only increases the hardware cost of the system but also makes fingerprint verification difficult because of the need to firstly decrypt the fingerprint data before physical matching may be performed. The use of encryption also introduces system and administrative overheads needed for managing cryptographic keys.

To this end, RidgeVault™ offers a convenient and secure solution that allows fingerprint to be stored in a “locked” form which can be used directly for fingerprint matching. With the use of RidgeVault™, the application can simply store the locked template in the database. Since the locked template is protected, there is no concern for privacy violation by the system. When there is a need for identity verification, the application may use RidgeVault™ to match the query fingerprint with the locked template directly. If the RidgeVault™ algorithm completes successfully, the identity of the subject can be established. More importantly, the whole identity verification can be completed without disclosing any fingerprint data stored in the database.

From the above description on fingerprinting as a specific embodiment of the biometric data input for the RidgeVault™ algorithm of the present invention, it would be obvious to a person skilled in the art of cryptography that there are many variations and alternative embodiments that may be used in substitution of the aforesaid procedure, modules, steps or processes. For example, other biometric data such as that acquired from iris scan, the equivalent θ parameter may be substituted with r or the increasing radius from centre of iris, in addition to the x- and y-coordinates of the feature spaces from the stroma. In facial biometrics, feature-based matching may be used to identify feature points on our face with their coordinates and angles and thus our present method may be applied accordingly.

Alternatively, for some of the parameters described above, a value that is outside of the prescribed or preferred range may still be acceptable to render our algorithm works although it may not be in a substantially effective or rigorous manner. Many of these various procedure, modules, steps or processes and alternative configurations or embodiments that are not specifically described herein may be used to effectively work the general concept and working principles of this invention. They are not to be considered as departures from the present invention but shall be considered as falling within the letter and scope of the following claims.

1. A method for generating cryptographic key from biometric data comprising the steps of:
(a) acquiring a subject's biometric image and extracting characteristic features therefrom in the form of vector sets (xᵢ, yᵢ, θᵢ) comprising coordinates x and y and directional parameter;
(b) randomly generating a key k and applying mathematical transformation to selected vector sets to encrypt said key k, including using threshold scheme and polynomial functions in mixture with randomly generated fake vector sets to produce randomly permutated set elements of key;
(c) constructing union of the vector sets of genuine and fake biometric data with randomly permutated set elements of key; and
(d) forming a locked template from the union of values from step (c).

2.-56. (canceled)
